(19) United States
(12) Patent Application Publication
(10) Pub. No.: US 2024/0315265 A1
(43) Pub. Date: Sep. 26, 2024

(54) METHOD AND SYSTEM FOR PHYTOSANITARY TREATMENT OF PRODUCE

(71) Applicant: United States of America as represented by the Secretary of Agriculture, Washington, DC (US)

(72) Inventors: Xikui Wei, Palmetto Bay, FL (US); Luis Bradshaw, Miami, FL (US)

(21) Appl. No.: 18/610,404

(22) Filed: Mar. 20, 2024

Related U.S. Application Data
(60) Provisional application No. 63/453,829, filed on Mar. 22, 2023.

(51) Int. Cl. A23B 7/005; A23L 3/00; A23L 3/10

(52) U.S. Cl. CPC A23B 7/0053; A23L 3/001; A23L 3/003; A23L 3/10

(57) ABSTRACT

A produce treatment system includes a treatment chamber that includes an inlet. The produce treatment system also includes one or more temperature sensors mounted within the treatment chamber. The one or more temperature sensors generate one or more temperature readings. The produce treatment system also includes a steam generator. A processor of a computing system controls delivery of steam from the steam generator to the inlet of the treatment chamber based at least in part on the one or more generated temperature readings.

### CROSS-REFERENCE TO RELATED APPLICATION

The present application claims the priority benefit of U.S. Provisional Patent App. No. 63/453,829 filed on Mar. 22, 2023, the entire disclosure of which is incorporated by reference herein.

### BACKGROUND

Fruits and vegetables grown in an agricultural setting are often treated with chemicals that are designed to improve crop quality, protect the crop from disease, protect the crop from insects and other organisms, etc. It is standard practice for end consumers to thoroughly wash fresh fruit and vegetables prior to consumption, and such washing will generally remove any chemicals on the surface of the fruit/vegetable. Washing will also generally remove insects/organisms present on the surface of the produce. However, simple washing of produce will often not kill organisms that are internal to the produce. Additionally, washing of produce by the end user generally occurs at their residence, which means that any insects and other organisms on the produce have already been introduced into the region where the produce was imported. Such importation of insects, etc. can be invasive, resulting in damage to the ecosystem of the import region. The importation of exotic organisms can also have a detrimental impact on local agricultural production.

### SUMMARY

An illustrative produce treatment system includes a treatment chamber that includes an inlet. The produce treatment system also includes one or more temperature sensors mounted within the treatment chamber. The one or more temperature sensors generate one or more temperature readings. The produce treatment system also includes a steam generator. A processor of a computing system controls delivery of steam from the steam generator to the inlet of the treatment chamber based at least in part on the one or more generated temperature readings.

In one embodiment, the one or more temperature sensors include a plurality of ambient temperature sensors that monitor a temperature of space within the treatment chamber. In such an embodiment, each ambient temperature sensor in the plurality of ambient temperature sensors generates an ambient temperature reading, and the processor compares the generated ambient temperature readings to an ambient temperature threshold. In another embodiment, the processor controls an amount of steam delivered by the steam generator based on the comparison of the generated ambient temperature readings to the ambient temperature threshold. In another embodiment, the processor controls the of steam delivered by the steam generator through control of a steam injection valve that receives the steam from the steam generator.

In one embodiment, the processor determines a highest temperature reading from the generated ambient temperature readings, and the processor compares only the highest temperature reading to the ambient temperature threshold. In another embodiment, the processor determines a lowest temperature reading from the generated ambient temperature readings, and the processor compares only the lowest temperature reading to the ambient temperature threshold. In another embodiment, the processor determines an average temperature reading of the generated ambient temperature readings, and the processor compares the average temperature reading to the ambient temperature threshold.

In one embodiment, the one or more temperature sensors include an internal produce temperature sensor that monitors an internal temperature of a piece of produce being treated within the treatment chamber. The internal produce temperature sensor generates an internal produce temperature reading, and the processor compares the generated internal produce temperature reading to an internal produce temperature threshold. In another embodiment, the processor controls an amount of steam delivered by the steam generator based on the comparison of the generated internal produce temperature reading to the internal produce temperature threshold. In another embodiment, the processor controls a volume of the steam delivered by the steam generator based on the comparison of the generated internal produce temperature reading to the internal produce temperature threshold. In one embodiment, the piece of produce includes a plurality of internal temperature sensors, and one or more additional pieces of produce spaced about the treatment chamber each include multiple internal temperature sensors.

In an illustrative embodiment, the processor determines that the one or more generated temperature readings satisfy a temperature threshold, and the processor maintains the temperature threshold within the treatment chamber or within a piece of the produce for a duration of time. In another embodiment, the processor controls a rate of temperature change based on the one or more generated temperature readings, and the processor controls the steam generator such that the rate of temperature change does not exceed a temperature rate change threshold. In another embodiment, the system includes an air circulation unit, and the processor controls the air circulation unit to circulate air within the treatment chamber. Control of the air circulation unit is based at least in part on the one or more generated temperature readings. In another embodiment, the system includes a water source, and the processor controls the water source to disperse water within the treatment chamber to cool the produce. Control of the water source is based at least in part on the one or more generated temperature readings. In another embodiment, the treatment chamber includes a double wall with insulation in between walls of the double wall.

An illustrative method for phytosanitary treatment of produce includes injecting steam into a treatment chamber that contains produce that is to be treated. The method also includes monitoring a temperature within the treatment chamber using one or more temperature sensors. The method further includes controlling, by a processor of a computing system, at least one of an amount of the steam injected and a temperature of the steam injected to achieve a desired temperature within the treatment chamber. The controlling is based on the monitoring via the one or more temperature sensors. Additionally, the desired temperature is high enough to kill an organism associated with the produce.

In an illustrative embodiment, the steam is injected by a steam generator, and the processor controls the steam generator or a valve connected to the steam generator to maintain the desired temperature for a predetermined duration of time. The predetermined duration of time is based at least in part on a type of the produce. In another embodiment, the one or more temperatures include a temperature sensor placed within a piece of the produce. In one embodiment, the method further includes controlling, by the processor, a water source to cool the produce.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 illustrates an embodiment of a system for phytosanitary treatment of agricultural produce in accordance with an illustrative embodiment.

FIG. 2 depicts operations to performed by a produce treatment system to treat produce in accordance with an illustrative embodiment.

FIG. 3 is a block diagram of a produce treatment system that is operated by a computing system in accordance with an illustrative embodiment.

### DETAILED DESCRIPTION

Washing fruits and vegetables with soap and light chemicals are among the most common approaches to sanitizing agricultural produce prior to consumption. Such practices are common among consumers, but they are impractical when employed at the time of harvest or import. As a result, agricultural produce harvesters, wholesalers, and importers are limited in their ability to quickly rid agricultural produce of pest organisms, many of which can cause spoilage, disease, or exotic species invasions. In general, there is a growing need to treat recently harvested agricultural produce more efficiently and efficaciously while also consuming significantly less energy than traditional systems.

The present application focuses on harvest-side sanitation systems and methods to mitigate invasive insect species and pathogenic microorganisms on or in fruits, vegetables, nuts, and other agricultural produce (hereinafter “produce”). The proposed system utilizes a steam treatment process that is precisely controlled to best preserve the quality of treated produce while effectively sanitizing. Phytosanitation by steam is superior to other chemical or non-chemical methods, such as methyl bromide fumigation and heat treatment with liquid water or forced hot air. Steam treatment leaves no harmful residue in treated produce, it consumes significantly less energy due to greater heat transfer efficiency, it uses a shorter treatment time, and has improved treatment uniformity.

In a first aspect, a system for phytosanitary treatment of produce includes a steam generator that generates steam and a treatment chamber that holds the produce while it is subjected to the steam. The steam generator can include an outlet that allows steam to be injected into an inlet (or opening) in the treatment chamber. The rate of steam injection can be further controlled, manually or automatically, e.g., by a valve within the outlet.

In an illustrative embodiment, the steam circulates within the treatment chamber and warms the produce placed therein to perform phytosanitation. The treatment chamber can be double walled in the case of using plastic sheets of material (e.g., a plastic tarp) or the chamber wall can otherwise be insulated with insulation material to substantially mitigate heat loss from within the treatment chamber. The temperature within the treatment chamber can be monitored and controlled with a computerized controller that is in direct communication with the steam injection valve, and which controls the volume of steam placed into the treatment chamber. The computerized controller can also control circulation of the steam inside the treatment chamber through a blower that pulls steam from and blows steam into the treatment chamber.

In one embodiment, the treatment chamber can be supported with a rigid frame. For example, plastic pipe or light-weight metal beams can be used to create a void space into which the produce can be placed. In various aspects, the rigid frame can be covered with a material that is also substantially impermeable, e.g., a plastic tarp or other sheet of material. In various aspects, the cover material has at least one opening to allow, e.g., the insertion of produce within the treatment chamber, the injection of steam and steam circulation components, the placement of temperature sensors, etc. In another embodiment, the treatment chamber can be double-walled and can include a space between the two layers. This space between the walls can be filled with insulation in one embodiment, or alternatively filled with air. For example, the double-walled treatment chamber can be in the form of a plastic inflatable chamber and may not include a rigid frame or other supporting structure. Alternatively, a single-walled structure can be used.

The phytosanitary treatment process can include generating steam of a temperature that substantially sanitizes the produce while maintaining produce integrity and freshness. The steam can be injected into the treatment chamber through a pipe or outlet, where the rate of injection can be controlled using a valve. The valve can be controlled manually or automatically and in response to a signal generated from a computerized controller that is in direct communication with the temperature sensors inside the treatment chamber. In one embodiment, the outlet is placed at the bottom of the treatment chamber, though it will be understood by those skilled in the art that the outlet can be placed anywhere along the internal surface area of the treatment chamber.

In an illustrative embodiment, the steam is injected and is distributed substantially homogeneously within the void space of the treatment chamber. In various aspects, the volume of steam needed to raise the temperature of produce is precisely controlled using a computerized controller. The computerized controller can monitor, e.g., temperatures, humidity, and other environmental variables within the treatment chamber and/or within the produce. The steam can be injected at a substantially gradual rate to best preserve the quality of treated agricultural produce while effectively killing targeted organisms in or on the agricultural produce.

The use of steam to conduct the phytosanitary treatment allows the system to be used in virtually any environment or location. For example, just 1 liter of water can generate 1600 liters of steam, which allows the system to operate in the absence of large water supplies. By using steam, the proposed system can also operate effectively without the use of a vacuum, which can sometimes damage the produce.

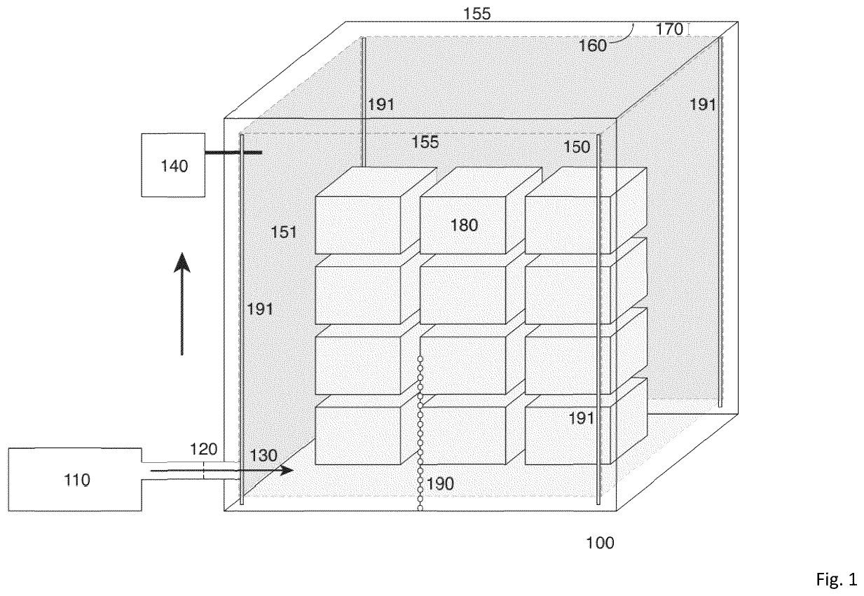

Multiple embodiments of a system and methods for phytosanitary treatment of agricultural produce are described herein. These embodiments are not intended to be limiting, and modifications, variations, combinations, etc., are possible and within the scope of this disclosure. FIG. 1 illustrates an embodiment of a system for phytosanitary treatment of agricultural produce in accordance with an illustrative embodiment. The system includes a steam generator 110 and a treatment chamber 100. In some embodiments, the steam generator 110 injects steam through an outlet 130 into the treatment chamber 100. In some embodiments, the volume of steam can be controlled through a valve 120 located within or at the mouth of the outlet 130. The outlet 130 of the steam generator 110 is in fluid communication with an inlet (e.g., opening) within a wall of the treatment chamber 100.

In some embodiments, the temperature of the steam injected into the treatment chamber 100 by the steam generator 110 is greater than 100° Celsius (C). In some further embodiments, the outlet 130 is positioned at the bottom of the treatment chamber 100, though those skilled in the art will understand that the outlet 130 can be placed anywhere along the inner surface of the treatment chamber 100. The outlet 130 enables steam to enter the treatment chamber through the inlet formed in the treatment chamber. In one embodiment, the inside of the treatment chamber 100 includes a void space 151 into which the steam diffuses and is substantially homogeneously dispersed. The void space 151 within the treatment chamber 100 can be maintained at a temperature of up to 55° C. in one embodiment. Alternatively, different temperatures may be used, as discussed herein.

In some embodiments, the temperature within the void space 151 of the treatment chamber 100 is maintained by a computerized controller 140 which controls the opening and closing of the valve 120. In some embodiments, the computerized controller 140 is in direct contact with temperature sensors within the void space 151 to monitor temperatures, e.g., using temperature sensors that generate electronic signals indicative of ambient temperature within the treatment chamber 100 and also pulp temperature of the produce being treated. In some embodiments, the computerized controller 140 can communicate with the steam generator 110 and/or the steam injection valve 120 to either increase or decrease the volume of steam injection to maintain, e.g., the ambient temperature within the void space 151 at 35° C., 40° C., 45° C., 50° C., 55° C., or higher depending on the type of produce being treated.

In some embodiments the computerized controller 140 communicates automatically with the steam generator 110. In one embodiment, the computerized controller 140 emits an alert when the void space temperature 151 is below or at a first desired temperature, e.g., 35° C. In some embodiments, the steam injection into the treatment chamber 100 is performed manually by, e.g., opening or closing fully or partially the steam injection valve 120. In other embodiments, the steam injection into the treatment chamber 100 is automatic and in response to a signal generated by the computerized controller 140. In some further embodiments, the volume and frequency of steam injection is regulated by the valve 120 either manually or automatically. For example, a void space 151 temperature below the desired temperature at that point of the treatment process is detected by the computerized controller 140, which subsequently transmits a signal to the valve 120 to increase the outlet 130 cross-sectional area through which steam can pass into the treatment chamber 100. In an alternative embodiment, the valve 120 can remain open, and steam volume can be controlled by turning the steam generator on and off.

In some embodiments, the treatment chamber 100 is enclosed by a two-walled and pliable material 155, e.g., a plastic tarp or an acrylic sheet, etc. The two-walled and pliable material 155 can include of an inner layer 150 and outer layer 160 that improves insulation. In some embodiments, the space 170 between the inner layer 150 and the outer layer 160 is greater than 3 inches and less than or equal to 15 inches, although other distances may be used in alternative embodiments. In some embodiments, the space 170 between the inner layer 150 and the outer layer 160 can be filled with insulation materials, e.g., fiberglass, cloth, wool, spray foam, etc., to further improve insulation. As shown, an opening 190 is formed into the two-walled and pliable material 155 to allow produce 180 to be inserted or removed from the void space 151 inside the treatment chamber 100. In some embodiments, the two-walled and pliable material 155 is supported by vertical rigid supports 191, e.g., a polyvinyl chloride (PVC) frame, a metal frame, etc. In alternative embodiments, the treatment chamber 100 is inflatable, removing the need for vertical rigid supports 191.

In some embodiments, the opening 190 is left open to allow the treatment chamber 100 to vent and cool. In some further embodiments, the valve 120 is configured to block the outlet 130 and to prevent steam from being injected into the treatment chamber 100 once a desired temperature is reached. In other embodiments, the agricultural produce is further cooled, e.g., by spraying cool water from a water source over the steam treated agricultural produce to facilitate a more rapid decrease in temperature. In some embodiments, the treatment chamber 100 is mobile and quickly assembled, e.g., in response to the need for emergency uses such as quarantine pests' outbreaks.

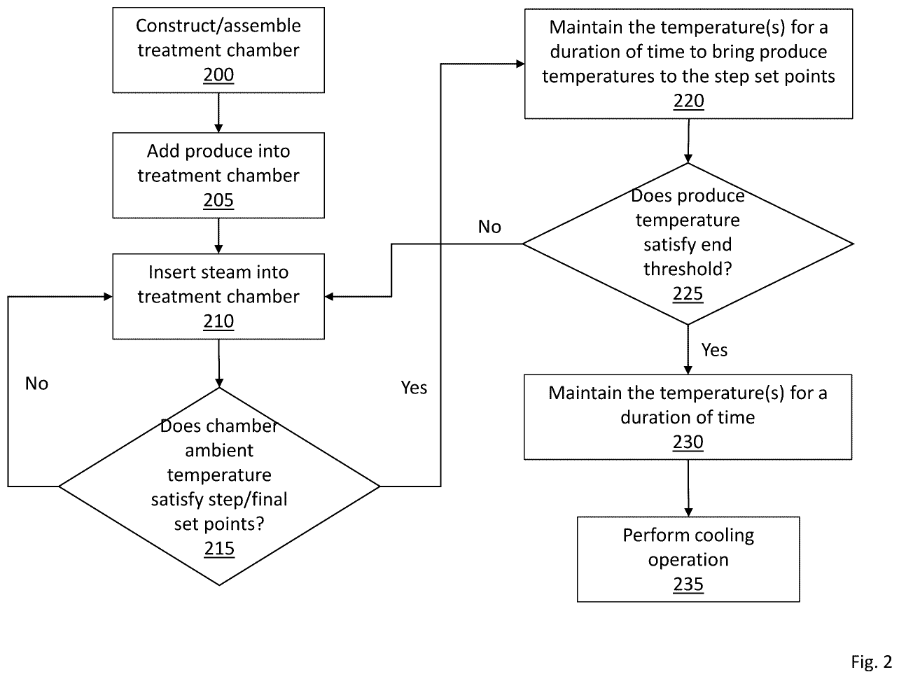

FIG. 2 depicts operations to performed by a produce treatment system to treat produce in accordance with an illustrative embodiment. In alternative embodiments, fewer, additional, and/or different operations may be performed. Additionally, the order of operations presented in the figure is not meant to be limiting. In an operation 200, the treatment chamber is assembled/constructed. In one embodiment, the treatment chamber is in the form of an inflatable, and assembling the treatment chamber includes inflating the chamber manually or with an air compressor. The treatment chamber can also be constructed by mounting one or more plastic sheets to one or more rigid structures, such as poles. In another embodiment, the treatment chamber can be a more permanent structure that is constructed using metal sheets, cement blocks, wooden beams, etc. In one embodiment, a shipping container (or other structure such as a train car) can be converted into a treatment chamber. In an illustrative embodiment, the treatment chamber is at least partially insulated to help maintain a desired temperature within the chamber. For example, walls, a ceiling, and/or a floor of the treatment chamber can be double walled to accommodate insulative material in between the walls. The insulative material can be fiberglass, air, wood chips, cloth, rigid sheet insulation, etc.

In some embodiments, the treatment chamber includes an inlet that is connected to an outlet of a steam generator. The inlet can be positioned in a wall, floor, or ceiling of the treatment chamber, and allows steam to enter the treatment chamber so that the ambient temperature within the chamber can be raised in a controlled way. In one embodiment, the inlet is positioned at a bottom of the treatment chamber, either at the floor or proximate to the junction between the floor and sidewalls. Assembly of the chamber can also include mounting an outlet of the steam generator to the inlet of the treatment chamber. Steam emitted from outlet can be controlled by a valve in one embodiment. Specifically, the valve can be automatically or manually controlled to adjust a sectional area of the outlet opening to control steam volume (i.e., the amount of steam). In an illustrative embodiment, the treatment chamber can also include a door or other opening through which produce can be inserted into the chamber. In one embodiment, the treatment chamber can include a removable or retractable roof/ceiling such that produce can be inserted through the top of the chamber. Alternatively, the door/opening can be in one of the walls of the treatment chamber.

Assembling the treatment chamber can also include mounting one or more temperature sensors within the chamber. For example, a first temperature sensor can be placed at the inlet where steam is inserted into the chamber (and/or at the outlet or valve), a second temperature sensor can be at a bottom (e.g., on a floor or lower wall) of the chamber, a third temperature sensor can be at a top (e.g., on ceiling or upper wall) of the chamber, a fourth temperature sensor can be at a center of the treatment chamber, etc. Alternatively, a single temperature sensor can be mounted within the treatment chamber. RTD (Resistance Temperature Detector) sensors can be used for temperature accuracy requirement reasons, but any type of temperature sensor known in the art may be used.

In another illustrative embodiment, one or more temperature sensors can also be inserted into one or more pieces of produce (e.g., into the pulp of a fruit, into the body of a vegetable, into the shell of a nut, etc.) that is placed into the treatment chamber. In this way, an internal temperature of the produce can be monitored to ensure that a desired lethal temperature is reached. The lethal temperature can be a threshold value that differs depending on the specific type of produce being treated and/or on the specific type(s) of pests that are to be eradicated from the produce. For example, the threshold temperature value can be low enough to protect the produce from heat damage and high enough to kill one or more specific types of organisms that may be present on or within the produce.

In an operation 205, produce is added into the treatment chamber. As discussed herein, any type of produce can be treated by the proposed system, including fruits, vegetables, nuts, legumes, flowers, plants, etc. The produce can be added manually by a user, by use of a conveyor belt system, by use of a forklift or other vehicle, etc. The produce can be added through the door or other opening formed in the wall(s) and/or ceiling of the treatment chamber. Once the produce is added, the door/opening can be closed or otherwise sealed to create an insulated environment in which heat can be retained for a duration of time.

In an operation 210, steam is inserted into the treatment chamber via a steam generator. Any type of steam generator known in the art may be used. The steam generator can be controlled manually in one embodiment. In another embodiment, a computing system is used to control insertion of steam by the steam generator. In one embodiment, the injected steam can have a temperature no greater than 200° C. A different maximum steam temperature can be used in alternative embodiments, such as 150° C., 175° C., 210° C., etc. The computing system can utilize the temperature sensor(s) to control the amount of steam inserted by the steam generator. In one embodiment, the amount of steam is controlled through a steam injection valve having an opening that can be adjusted to control steam flow.

In an operation 215, a determination is made regarding whether the ambient temperature within the treatment chamber satisfies a temperature set point, e.g., step or final temperature set points. The ambient temperature set point (or threshold) is a desired temperature that i) is high enough to gradually warm up the produce, and ii) low enough that the produce is not damaged. In an illustrative embodiment, the ambient temperature set point can be between 35° C.-55° C., although other values may be used, such as 30° C., 58° C., 60° C., etc. In one embodiment, the ambient temperature set point(s) can be based on an initial temperature of the produce. For example, in one embodiment, the ambient temperature set point can be 10° C. greater than an initial internal temperature of the produce. Alternatively, a different value can be used, such as 8° C., 12° C., 15° C., etc. greater than the initial internal temperature of the produce.

The determination of whether the ambient temperature set point is satisfied can be made by the computing system in response to sensor readings received by the computing system from the temperature sensor(s) mounted within the treatment chamber. Alternatively, the determination can be manually made by a user of the system. If it is determined that the ambient temperature does not satisfy the temperature set point (i.e., the ambient temperature is too low), the system continues to insert steam into the treatment chamber in the operation 210.

In embodiments in which a plurality of temperatures sensors are used to determine the ambient temperature of the treatment chamber, the computing system (or user operating the system manually) will receive a plurality of temperature sensor readings corresponding to the different sensors. In one embodiment, the system can take an average of the temperature sensor readings to determine if the ambient temperature threshold is satisfied. Alternatively, the determination can be based on the highest temperature recorded by one of the sensors. In another alternative embodiment, the determination can be based on the lowest temperature recorded by one of the sensors.

If it is determined in the operation 215 that the ambient temperature satisfies the ambient temperature step or final set points, the system maintains the temperature(s) within the treatment chamber for a duration of time to bring produce temperatures to the step set points in an operation 220. In an operation 225, the system determines whether internal produce temperature satisfies an internal produce end temperature threshold in an operation 225. In some embodiments, the internal produce end temperature threshold is different from the ambient temperature temperature set point(s). Alternatively, the set point(s) and internal produce end temperature threshold can have the same value. In one embodiment, the internal produce end temperature threshold is in the range of 43° C. to 50° C. Alternatively, other values may be used, such as 35° C., 40° C., 55° C., 60° C., etc.

The determination of whether the internal produce end temperature threshold is satisfied can be made by the computing system in response to sensor readings received by the computing system from the temperature sensor(s) mounted within the produce. Alternatively, the determination can be manually made by a user of the system. If it is determined that the internal produce temperature does not satisfy the temperature threshold (i.e., the internal produce temperature is too low), the system continues to insert steam into the treatment chamber in the operation 210.

In embodiments in which a plurality of temperatures sensors are used to determine the internal produce temperature, the computing system (or user operating the system manually) will receive a plurality of temperature sensor readings corresponding to the different sensors. For example, in some embodiments, a single piece of produce can include multiple temperature sensors, and a plurality of pieces of produce (each having multiple temperature sensors) can be distributed around the treatment chamber to help ensure that all of the produce is being properly treated. Alternatively, a plurality of different pieces of produce can each include a single temperature sensor. In an illustrative embodiment, the determination can be based on the lowest temperature recorded by one of the sensors inserted in the produce.

In an alternative embodiment, the operation 225 can be performed prior to the operation 215 such that determinations are made regarding whether the internal produce temperature satisfies the internal produce temperature threshold prior to determination of whether the ambient temperature threshold is met. Similarly, in another alternative embodiment, only the internal produce temperatures sensors (i.e., and not the ambient temperature sensors) may be used.

In another illustrative embodiment, the system can also control the rate of temperature change within the treatment chamber (and/or within the produce) to ensure that the temperature change is gradual. A gradual temperature increase can help protect the quality of the produce. For example, in addition to monitoring the overall temperature, the computing system can ensure that the rate of temperature change (either ambient or internal to the produce) does not exceed a temperature change rate threshold, which can be measured in terms of Δ° C./second, Δ° C./minute, etc. The computing system can then control operation of the steam generator and/or the steam injection valve in the operation 210 to ensure that the rate of temperature change remains within the temperature change rate threshold. In one embodiment, the computing system can also control an air circulation unit (e.g., a fan) to circulate air within the treatment chamber such that the rise in temperature is more uniform throughout the chamber.

In an illustrative embodiment, the temperature change rate varies in different use cases, and can be based on an initial temperature of the produce as determined by the temperature sensor(s). For example, produce that is initially cool (e.g., less than 10° C.) can have a lower temperature change rate to ensure that the produce temperature does not change too rapidly, which may deteriorate the produce. Similarly, produce that is initially warm can have a higher temperature change rate threshold.

If it is determined in the operation 225 that the internal produce temperature satisfies the internal produce temperature threshold, the system maintains the temperature(s) for a duration of time in an operation 230. In one embodiment, the system can maintain the temperatures by continuing to monitor the ambient temperature sensors in the operation 215 and/or by continuing to monitor the internal produce temperature sensors in the operation 225. Specifically, the system controls the steam generator and/or the steam injection valve in the operation 210 to ensure that the temperature threshold(s) are maintained for the desired duration of time. The duration of time can be, for example, 1 minute, 3 minutes, 5 minutes, 10 minutes, 30 minutes, 60 minutes, etc. The duration of time can be based on the type of organism being targeted by the system and/or by the type of produce being treated.

Still referring to the operations 210-230, in an illustrative embodiment, the ambient chamber temperature is for providing heat energy to raise the produce temperature. Higher chamber ambient temperatures will raise the produce temperature faster and shorten the treatment time. But for best preserving produce quality, chamber ambient temperature cannot be too high for the purpose of not damaging the produce to be treated. Therefore, several levels of chamber temperatures (step set points) can be used during the whole treatment process. As an example, at the beginning of the treatment when the produce initial temperature is low, for example below 20° C., the chamber ambient temperature can initially be raised only to about 30° C. (i.e., a first temperature set point). The ambient chamber temperature can be maintained at that temperature (i.e., the first temperature set point) for a period of time to slowly warm up the produce internal temperature. When the produce reaches an internal temperature threshold (e.g., 30° C.), the system can raise the chamber temperature to about 40° C. (i.e., a second step set point) and maintain at that temperature for some time to bring the produce temperature up to another temperature threshold, then to the next level of set point temperatures, and so on until the final desired temperature is reached. Controlling the chamber ambient temperature helps to maximally preserve the quality of produce under treatment. Produce internal temperatures will determine if the pests will be killed completely and when the treatment should be concluded.

Chamber ambient temperature increases very quickly when steam is injected (reaching the step set points within a few minutes based on the temperature change rate we set at), but the produce internal temperature increases slowly because it changes by absorbing the heat energy from the chamber ambient temperature. Therefore, when each step of chamber ambient temperature is met, a period of time maintaining at that step set point of chamber temperature is used in order to bring the produce internal temperature up to the set point temperature. Then insertion of steam to the next chamber ambient temperature set point. This process is continued until the final internal produce temperature (treatment target temperature) is met.

In an operation 235, the system performs a cooling operation to cool the produce off after the treatment has been conducted. The cooling operation can include stopping the insertion of steam by the steam generator by turning off the steam generator and/or closing the valve. The cooling operation can also include activating a water source to spray water onto the produce. The cooling operation can also include opening a door or vent of the treatment chamber or otherwise creating an opening that allows hot air to escape from the treatment chamber. In an alternative embodiment, the cooling operation may not be performed by the system.

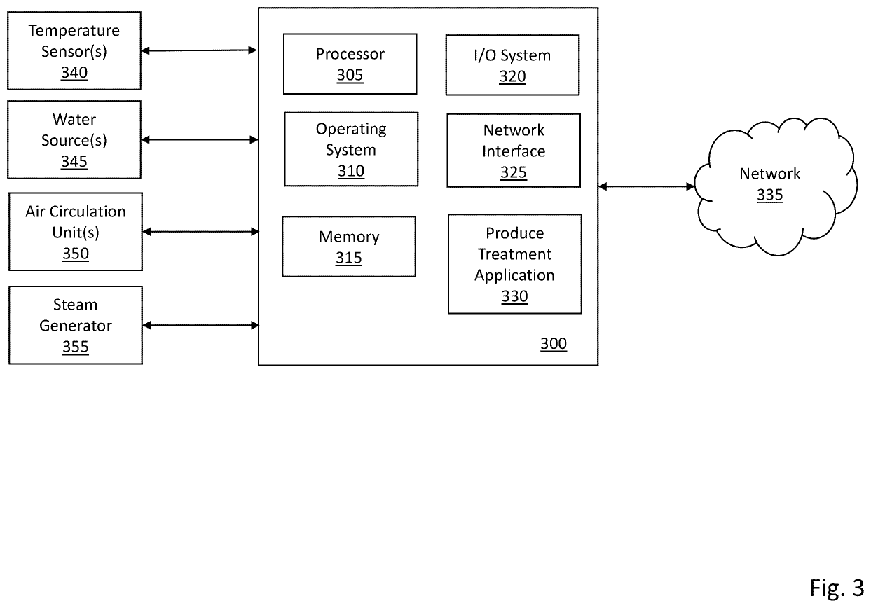

As discussed herein, in an illustrative embodiment, a computing system can be used to control operation of the produce treatment system. Specifically, the computing system can be used to perform any of the operations described herein. As an example, FIG. 3 is a block diagram of a produce treatment system that is operated by a computing system 300 in accordance with an illustrative embodiment. In one embodiment, the computing system 300 is in direct communication with temperature sensor(s) 340, water source(s) 345, air circulation unit(s) 350, the steam generator 355 (including a valve thereof), etc. of the produce treatment system. In an embodiment in which the computing system 300 is remote from the treatment chamber, the computing system 300 can communicate with the temperature sensor(s) 340, the water source(s) 345, the air circulation unit(s) 350, the steam generator 355, etc. through a network 335.

The computing system 300 includes a processor 305, an operating system 310, a memory 315, an input/output (I/O) system 320, a network interface 325, and a produce treatment application 330. In alternative embodiments, the computing system 300 may include fewer, additional, and/or different components. The components of the computing system 300 communicate with one another via one or more buses or any other interconnect system. The computing system 300 can be any type of computing device (e.g., smartphone, tablet, laptop, desktop, custom computing device, etc.) that has sufficient processing power to perform the operations described herein.

The processor 305 can be in electrical communication with and used to control any of the system components described herein. For example, the processor can be used to execute the produce treatment application 330, process received temperature readings from the temperature sensor(s) 340, control the steam generator 355 and/or its associated valve, control the water source(s) 345, control the air circulation unit(s) 350, etc. The processor 305 can be any type of computer processor known in the art, and can include a plurality of processors and/or a plurality of processing cores. The processor 305 can include a controller, a microcontroller, an audio processor, a graphics processing unit, a hardware accelerator, a digital signal processor, etc. Additionally, the processor 305 may be implemented as a complex instruction set computer processor, a reduced instruction set computer processor, an x86 instruction set computer processor, etc. The processor 305 is used to run the operating system 310, which can be any type of operating system.

The operating system 310 is stored in the memory 315, which is also used to store programs, user data, network and communications data, peripheral component data, the produce treatment application 330, and other operating instructions. The memory 315 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc. In some embodiments, at least a portion of the memory 315 can be in the cloud to provide cloud storage for the system. Similarly, in one embodiment, any of the computing components described herein (e.g., the processor 305, etc.) can be implemented in the cloud such that the system can be run and controlled through cloud computing.

The I/O system 320 is the framework which enables users and peripheral devices to interact with the computing system 300. The I/O system 320 can include a display, one or more speakers, one or more microphones, a keyboard, a mouse, one or more buttons or other controls, etc. that allow the user to interact with and control the computing system 300. The I/O system 320 also includes circuitry and a bus structure to interface with peripheral computing devices such as power sources, universal service bus (USB) devices, data acquisition cards, peripheral component interconnect express (PCIe) devices, serial advanced technology attachment (SATA) devices, high definition multimedia interface (HDMI) devices, proprietary connection devices, etc.

The network interface 325 includes transceiver circuitry (e.g., a transmitter and a receiver) that allows the computing system 300 to transmit and receive data to/from other devices such as the temperature sensor(s) 340, the water source(s) 345, the air circulation unit(s) 350, the steam generator 355, remote computing systems, servers, websites, etc. The network interface 325 enables communication through the network 335, which can be one or more communication networks. The network 335 can include a cable network, a fiber network, a cellular network, a wi-fi network, a landline telephone network, a microwave network, a satellite network, etc. The network interface 325 also includes circuitry to allow device-to-device communication such as Bluetooth® communication.

The produce treatment application 330 can include software and algorithms in the form of computer-readable instructions which, upon execution by the processor 305, performs any of the various operations described herein such as processing received ambient temperature readings from ambient temperature sensors, processing received internal produce temperature readings from internal produce temperature sensors, determining one or more temperature thresholds based on initial produce temperatures, comparing temperature readings to one or more temperature thresholds, determining a rate of temperature change (ambient and/or internal produce), controlling the steam generator 355 and/or valve based on the temperature threshold comparisons and/or the determined rate of temperature change, controlling the steam generator 355 to maintain temperature(s) for a given duration of time, controlling the water source(s) 345 to cool the produce, controlling the air circulation unit(s) (e.g., fans) 350 to cool the produce, etc. The produce treatment application 330 can utilize the processor 305 and/or the memory 315 as discussed above. In an alternative implementation, the produce treatment application 330 can be remote or independent from the computing system 300, but in communication therewith.

In summary, described herein are systems and methods in which the treatment of produce is implemented using steam to heat and sanitize fruits, vegetables, nuts and other agricultural produce in an enclosed environment. The system includes a steam generator that injects steam into a treatment chamber into which agricultural produce has been placed. In one embodiment, the steam treatment system can be mobile and designed for rapid assembly so as to accommodate, e.g., emergency quarantine protocols of a pest outbreak.

The steam introduced into the treatment chamber raises ambient and produce temperatures such that the environment becomes lethal to pest organisms, while still being safe for the treated agricultural produce. The system can also include a steam circulation mechanism that accelerates the distribution of steam heat evenly throughout treatment enclosure. In some embodiments, the method of steam treatment can be used to effectively kill insects, pathogens, nematodes, snails, and other harmful organisms inhabiting fruit, tree nuts, groundnuts, seeds, legumes, and vegetables. In another embodiment, this steam treatment process can also be applied to culled fruit or fruit waste after processing for safe disposal. Using the proposed system, agricultural produce quality is preserved due to high humidity, homogeneous heat distribution, controlled steam injection and circulation, precise control of agricultural produce temperature, and optimal heating time.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A produce treatment system comprising:
a treatment chamber, wherein the treatment chamber includes an inlet;
one or more temperature sensors mounted within the treatment chamber, wherein the one or more temperature sensors generate one or more temperature readings;
a steam generator, wherein a processor of a computing system controls delivery of steam from the steam generator to the inlet of the treatment chamber based at least in part on the one or more generated temperature readings.

2. The system of claim 1, wherein the one or more temperature sensors include a plurality of ambient temperature sensors that monitor a temperature of space within the treatment chamber.

3. The system of claim 2, wherein each ambient temperature sensor in the plurality of ambient temperature sensors generates an ambient temperature reading, and wherein the processor compares the generated ambient temperature readings to an ambient temperature threshold.

4. The system of claim 3, wherein the processor controls an amount of steam delivered by the steam generator based on the comparison of the generated ambient temperature readings to the ambient temperature threshold.

5. The system of claim 4, wherein the processor controls the amount of steam delivered by the steam generator through control of a steam injection valve that receives the steam from the steam generator.

6. The system of claim 3, wherein the processor determines a highest temperature reading from the generated ambient temperature readings, and wherein the processor compares only the highest temperature reading to the ambient temperature threshold.

7. The system of claim 3, wherein the processor determines a lowest temperature reading from the generated ambient temperature readings, and wherein the processor compares only the lowest temperature reading to the ambient temperature threshold.

8. The system of claim 3, wherein the processor determines an average temperature reading of the generated ambient temperature readings, and wherein the processor compares the average temperature reading to the ambient temperature threshold.

9. The system of claim 1, wherein the one or more temperature sensors include an internal produce temperature sensor that monitors an internal temperature of a piece of produce being treated within the treatment chamber, wherein the internal produce temperature sensor generates an internal produce temperature reading, and wherein the processor compares the generated internal produce temperature reading to an internal produce temperature threshold.

10. The system of claim 9, wherein the processor controls an amount of steam delivered by the steam generator based on the comparison of the generated internal produce temperature reading to the internal produce temperature threshold.

11. The system of claim 9, wherein the piece of produce includes a plurality of internal temperature sensors, and wherein one or more additional pieces of produce spaced about the treatment chamber each include multiple internal temperature sensors.

12. The system of claim 1, wherein the processor determines that the one or more generated temperature readings satisfy a temperature threshold, and wherein the processor maintains the temperature threshold within the treatment chamber or within a piece of the produce for a duration of time.

13. The system of claim 1, wherein the processor controls a rate of temperature change based on the one or more generated temperature readings, and wherein the processor controls a steam injection valve such that the rate of temperature change does not exceed a temperature rate change threshold.

14. The system of claim 1, further comprising an air circulation unit, wherein the processor controls the air circulation unit to circulate air within the treatment chamber.

15. The system of claim 1, further comprising a water source, wherein the processor controls the water source to disperse water within the treatment chamber to cool the produce, and wherein control of the water source is based at least in part on the one or more generated temperature readings.

16. The system of claim 1, wherein the treatment chamber includes a double wall with insulation in between walls of the double wall.

17. A method for phytosanitary treatment of produce, the method comprising:
injecting steam into a treatment chamber that contains produce that is to be treated;
monitoring a temperature within the treatment chamber using one or more temperature sensors; and
controlling, by a processor of a computing system, an amount of the steam injected to achieve a desired temperature within the treatment chamber, wherein the controlling is based on the monitoring via the one or more temperature sensors, and wherein the desired temperature is high enough to kill an organism associated with the produce.

18. The method of claim 17, wherein the steam is injected by a steam generator, and wherein the processor controls the steam generator or a valve connected to the steam generator to maintain the desired temperature for a predetermined duration of time, wherein the predetermined duration of time is based at least in part on a type of the produce.

19. The method of claim 17, wherein the one or more temperature sensors include a temperature sensor placed within a piece of the produce.

20. The method of claim 17, further comprising controlling, by the processor, a water source to cool the produce.
